(19) United States
(12) Patent Application Publication
(10) Pub. No.: US 2024/0157325 A1
(43) Pub. Date: May 16, 2024

(54) A REACTOR STRUCTURE OF PROVIDING ENERGIZATION

(71) Applicant: TENOKS ARITMA TEKNOLOJILERI SANAYI VE TICARET ANONIM SIRKETI, Dilovasi, Kocaeli (TR)

(72) Inventors: Ali Mutlu GÜNDÜZ, Dilovasi, Kocaeli (TR); Yusuf Hikmet KAYA, Dilovasi, Kocaeli (TR); Sebahittin KORKMAZ, Dilovasi, Kocaeli (TR)

(21) Appl. No.: 17/779,707

(22) PCT Filed: Jun. 29, 2021
(86) PCT No.: PCT/TR2021/050672

§ 371 Date: May 25, 2022

(30) Foreign Application Priority Data
Jun. 17, 2021 (TR) 2021/009921

(51) Int. Cl. B01J 19/08; B01J 19/00

(52) U.S. Cl. CPC B01J 19/088; B01J 19/0053; B01J 2219/0828; B01J 2219/0841; B01J 2219/0875

(57) ABSTRACT

A reactor structure for providing energization , wherein a sustainable and stable mechanism is achieved for each step of the energizing process and which is capable of energizing together with a voltage of 50-100 kV and provides for both small-sized portable and factory-sized applications.

### TECHNICAL FIELD

The invention relates to a reactor structure of providing energization.

In particular, the invention relates to a reactor structure of providing energization, describes how a sustainable and stable mechanism is achieved for each step of the energizing process which is capable of energizing with a certain voltage system and provides for both small-sized portable and factory-sized.

### BACKGROUND OF THE INVENTION

Examples of patents with different shapes and assemblies (US20190351125, US20180264160, US20180264405, US20180112317, US20160251220) show how they are highly oxidized and well-defined assemblies with different mechanisms in general for energizing systems.

Energizing or oxidation-related mechanisms may include voltage-operated, oxidation-reducing material-driven structures, using a photocatalysis mechanism, or plasma-based structures based on the physical or chemical systems they support.

The most important problem among these structures is that sustainability is difficult and each system has side effects or provides production in limited compositions to energize in the same composition.

In addition, the high energy use and the interruption of the structures used in order to achieve the required efficiency, or the destructive and damaging side effects of the energized systems are among the side effects to be considered.

In a previously studied system, in the patent numbered US20110017066, a polyaniline-type conductive polymer provides water-soluble oxygen with its high oxidation and reduction properties and modifies its properties by providing electrons due to its chemical structure. To achieve this, an electrically deoxidizing potential is provided and if electrons are continuously directed to polyaniline, energized structures will continue to form in water. Complications on the surface of the polyaniline structure in long use restrict the formation of energized structures. Therefore, what is meant in this invention containing polyaniline is to provide the presence of water between the anode and the cathode containing the conductive polymer polyaniline, and to deoxidize the oxygen dissolved in the water with the application of electricity. When the mechanism is examined, the cathode for the energizing process is rotated and arranged to interact with water in a horizontal plane. Thus, the system describes the production of systems energized by a conductive polymer and also by water.

In another exemplary technique, a system has been developed that provides stable energizing in nitrite nitrogen without forming nitrate nitrogen. According to the explanation of this system with patent number US20210147270, ammonia is biologically oxidized, but this structure can be concentrated as nitrite before it progresses to nitrate. In this system, especially non-oxidized nitrogen-based system is used. The biological sludge system works with a certain loading potential, especially by bringing the pH ratio to the range of 8-10.

There are different applications to produce highly efficient and energetic ozone. Tabata, Youichiro; et al, While describing the device, he mentions a system that looks like a multiple shelf system and produces ozone and energizes with high efficiency. A low-voltage electrode surrounds a disk-shaped electrode structure, which is covered with multiple layers and is accompanied by a heat sink. The system applied with electrodes produces ozone with high efficiency,

In the patent application US20020076370, radicals and high energy gas systems are produced by Corona discharge method. A porous solid membrane type mechanism is used for this system. Thus, by means of Corona, structures such as bacteria and viruses are cleaned by the semi-stable radicals obtained. Looking at the mechanism, there is a pulse-controlled corona discharge system and ozone production can be realized.

In the patent application numbered US20030150708, a system that selectively directs the air and contains copper, titanium dioxide or silver in the directed place is defined. A UV source is directed at the source containing different metal oxides and has a wavelength of about 185 nm. It is reported that when air is directed and UV light is applied to the metal oxide mixture, energetic mixtures such as ozone with hydroxyl radicals or superoxide structures are obtained. The device is also suitable for cleaning the air.

In the patent application numbered US20200095125, a special mechanism is described for the synthesis of energetic allotropes. This energizing reactor has an electrically grounded outer surface and an electrically positive inner surface within the tube. There are different plates connected to each other by cables on the inner surface. An outer jacket closes the tube and provides the environment for gas production to come into the reactor and be energized. There is also another external link to apply corona.

The patent study numbered US20170334750 clearly shows that instead of making energetic modifications only for gas systems, energizing can be carried out in the solvent system by providing the necessary infrastructure and technical details.

In the study described for this, the electrolyzer is set to use impure water. In this way, ions such as Ca and Mg can provide modulation. In the electrolysis cell, a solid electrolyte separation cell whose membrane electrode structure is prepared with a cation exchange membrane is designed. The anode and cathode are compressed as desired and glued together. It has also been observed that hydroxide structures are formed for protection purposes. Auxiliary and complementary parts are important in the production of energized structures.

In the patent US20070134140, a system that is integrated, very cheap and capable of producing energized gas at high capacities is mentioned. An n-phase inverter is used for AC voltage and this n-phase AC is converted to high voltage AC. For the production of energized gas, the structure is divided into different parts. And these sections are used as discharge chambers. Each energy generating structure contains high voltage terminals and also a low voltage terminal, which is common for energized systems. Each room or zone affects the n-phase AC discharge system and assists in the generation of high-energy gas.

There are many systems in which energized gases are prepared and vary according to the type of gas. In one of them, Iseki, Masahiro; et al. US20030052062 uses an electrochemical method for nitrogen energizing to obtain energized nitrogen by treating with HOCl from the anode and cathode system separated by a cation exchange membrane in water.

Study US20160346726 specifically examines the modulation of atmospheric structures and pollutants such as NO, NO2 or SO2 with energetic and non-ionic Cl2O. Gases taken into a reactor environment are also interacted with an aqueous metal oxide. Thus, unexpectedly, it is ensured that the pollutants are removed with an energetic structure.

Hydrocarbons can be modulated together with energetic structures. In this structure, numbered US20170167238, loaded and high energy electrons or ions are interacted with hydrocarbons and energized them.

In the patent numbered US20170107128, Buschmann; Wayne mentions a structure that can provide peroxides, peracids or reactive oxygen species in it. The system contains an electrochemical structure and continues to work with different feeds.

According to the patent US20200240025, energizing can also be carried out as oxidation of double bonds.

Another patent application, CN109896744, describes the production of borosilicate glasses, which are generally used in the nuclear industry. According to the design of the nuclear reactor, very long structures up to 3000 mm can be obtained. The main purpose here is to provide an effective neutron absorption. Na2O, K2O, H3BO3, K2CO3, Na2CO3, components are mixed in different proportions and cooked at 1700 degrees.

In this system, there is no nanometric coating, no special holes, and the presence of the radiation source is clearly indicated.

Another patent application, EP2377609A1, describes a phototube design that basically treats the gas medium passing through it with a photochemical method. Such a photochemical reactor represents an axially designed radiation unit and a similarly placed radiation source surrounded by the reactor vessel. Thus, a gap is formed between the reactor wall and the radiation source, thereby creating a radiation volume. By means of a cap that covers the head and the end, the gas entry and exit points are determined. In order to adjust the gas density and turbulence of the tubular system, one or more gas channels are added to the system in connection with the specified space.

In this system, there is no nanometric coating, no special holes, and the presence of the radiation source is clearly indicated.

According to the patent number JPS627606, a device and system that produces ozonated water is described. The gas system transmits the air to the dust removal system with a special collector and the air is sent to the part where ozone will be produced through the outlet pipe. The ozone system contains many electrodes in a box. Many reagents made of borosilicate glass and in sheet form are contained in boxes. Borosilicate glasses are intermittently combined with shrouded stainless steel structures. It is used by changing electrodes with different polarities. A voltage of 5 kV is applied to the electrodes using an AC circuit in the form of a sine wave. The high voltage power unit has features that can change the voltage to be applied to the electrodes from 100 V to 5000 V. When voltage is applied from this source, electricity is generated between the electrodes and ozone emerges from the ionized atmosphere when air is passed. When this ozone-containing ionized gas is directed to a solution containing KMnO4 in a stainless steel container, a system containing approximately 7 times more oxygen than normal water is obtained.

The voltage level used here is very low and the borosilicate glass is used in the form of a sheet, not a tube. Also, the KMnO4 solution allows the system to modulate quite differently.

In the U.S. Pat. No. 6,500,771B1, borosilicate glasses or phosphoborosilicate structures are obtained at low temperature by using the high density chemical vapor deposition method. Here, silane derivatives, Boron and Phosphorus atoms, doping atoms and oxygen are defined as silicon source. RF plasma is continued with a certain plasma density and the desired doped borosilicate glass coating is formed. The most important feature of the discovery is that the flow property of boron-containing silicate glass has been improved in such a way that it does not form voids and forms a good film.

In this patent, only the explanations about developing a special borosilicate glass are included.

A patent number GB1401692A mentions ozonization provider 2 coaxial tubes. These tubes, which have a container on the outside, consist of a dielectric material, one of which is determined to form a metal electrode, and the other is supported by a conductive liquid electrode. Thus, air or oxygen-containing gas can be passed between these two electrodes. However, in order to prevent overheating, a cooler that first removes the heat from the metal electrode, and also a fluid that is circulated in the system and passed over the dielectric structure in order to remove the heat from the second dielectric tube is mentioned. Varying voltages can be applied to these electrodes and gas caps can be formed by forming the inlet and outlet parts of the tubes. The varying voltage applied here usually varies between 500 Hz and 20 KHz. This structure was produced in a manipulable form to control the amount of ozone produced.

Although the system uses borosiliact glass, with a focus for ozone generation, there is a problem with low voltage settings, the system being a large block, requiring cooling due to excessive heat.

The patent number GB1370212A mentions a structure based on the application of ceramic coatings, which envisages a more stable system related to the previously obtained patent GB 1310364 with ozone generator identification. As stated in patent GB 1310364, a Corona reactor (open plasma reactor) consists of a plurality of individual airtight cells. This structure provides temperature control by means of a cooler. Therefore, the GB1370212A patent emphasizes that if the reactor and cells are operated together on a special porcelain enamel structure, a more advantageous and efficient environment will be created.

Due to the above-mentioned reasons, a new reactor structure of providing energization was needed.

### Disclosure of the Invention

Based on this position of the technique, the aim of the invention is to introduce a new reactor that eliminates the existing disadvantages and provides energizing.

Another aim of the invention is to present a structure that eliminates the destructive and damaging side effects of energized systems.

Another aim of the invention is to present a structure that is much more stable and sustainable at the voltage values used.

Another aim of the invention is to present a structure whose size can be adjusted as desired.

Another aim of the invention is to present a structure that can be standardized for production in both laboratory type and factory dimensions.

Another aim of the invention is to present a structure that can reach high voltages with desired efficiency without the need for some extra auxiliary systems such as UV.

Another aim of the invention is to present a structure that can use a voltage of 50-100 kV in a desired environment with the desired efficiency.

Another aim of the invention is to present a structure that provides heat distribution in a suitable way so that the applied tension does not damage the glass.

Another aim of the invention is to provide a structure with high UV resistance, controllable oxidation properties and resistant to heating.

Another aim of the invention is to provide a controlled structure in the dielectric structure.

### EXPLANATION OF FIGURES

FIG. 1 is a representative side view of the reactor structure of providing energization, which is the subject of the invention.

FIG. 2 Top and side view of the reactor structure of providing energization, which is the subject of the invention.

### REFERENCE NUMBERS

A—Reactor Structure of Providing Energization
B—Gas to be Energized
C—Energized Gas
1. PA6 Reactor Cover
2. Reactor Cell
3. Nano Coated Borosilicate Electron Tube
4. SS304 Electrode Wire
5. Pores
6. 1000 Pore
7. Conical Nanopore

### DETAILED DESCRIPTION OF THE INVENTION

In this detailed explanation, the innovation, which is the subject of the invention, is explained only with examples that will not have any limiting effect on the subject.

The invention relates to a reactor structure of providing energization (A) , describes how a sustainable and stable mechanism is achieved for each step of the energizing process which is capable of energizing together with a voltage of 50-100 kV and provides for both small-sized portable and factory-sized characterized in that; comprises, reactor cell (2) positioned to ensure that the gas to be energized (B) is turned into plasma by applying 50-100 kV with the AC circuit, the nano-coated borosilicate electron tube (3) which is formed between the said lower and upper reactor cell (2), which has great resistance to heating and cracking that may occur due to the applied high voltage and pores (5) that provide proper heat distribution so that the voltage to be applied on the said nano-coated borosilicate electron tube (3) does not damage the nano-coated borosilicate electron tube (3).

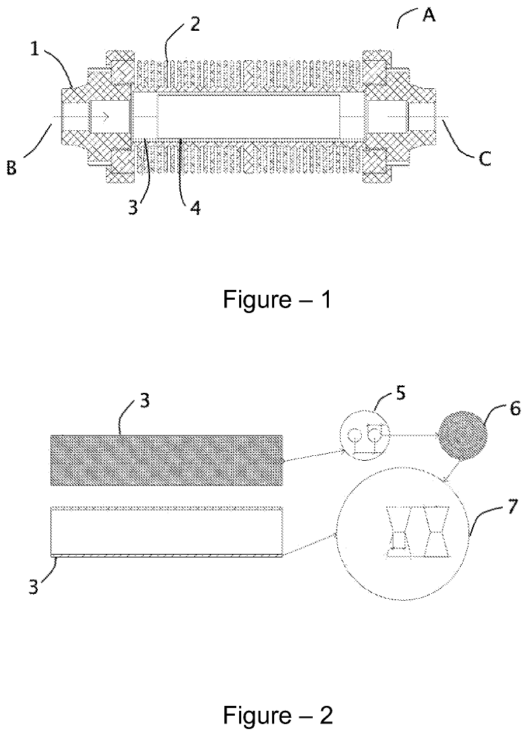

FIG. 1 shows a representative side view of the reactor structure of providing energization (A), which is the subject of the invention.

FIG. 2 shows top and side view of the reactor structure of providing energization (A), which is the subject of the invention.

The reactor structure of providing energization (A) according to invention consists main parts of gas to be energized (B), energized gas (C), PA6 reactor cover (1) where said gas to be energized (B) enters the reactor structure of providing energization (A), reactor cell (2) positioned to ensure that the gas to be energized (B) is turned into plasma by applying 50-100 kV with the AC circuit, the nano-coated borosilicate electron tube (3) which is formed between the said lower and upper reactor cell (2), which has great resistance to heating and cracking that may occur due to the applied high voltage, SS304 electrode wire (4) which is positioned on the top and bottom of the said nano-coated borosilicate electron tube (3) to allow the application of high voltage for the gas to be energized (B) coming from the outside, and which forms dielectric material to enable the nano-coated borosilicate electron tube (3) to act as a capacitor, pores (5) that provide proper heat distribution so that the voltage to be applied on the said nano-coated borosilicate electron tube (3) does not damage the nano-coated borosilicate electron tube (3), conical nanopore (7), which is formed by opening 1000 pores (6) and provides the formation of energized gas (C) mixture with the electron discharge formed on the said nano-coated borosilicate electron tube (3).

Said reactor structure of providing energization (A) is basically based on the use of a nano-coated borosilicate electron tube (3) glass. As it is known, borosilicate glasses are structures that show great resistance to heating and cracking. The main reason for this is the special regions formed by the boron atom in the glass structure.

Nano-coated borosilicate electron tubes (3) with a glass length of about 15 and a diameter of 4 cm are suitably prepared for high energizing. On the surface of the nano-coated borosilicate electron tube (3), nanometric pores (5) are opened in a regular manner and heat distribution is provided in a suitable way so that the applied voltage does not damage the nano-coated borosilicate electron tube (3).

The aforementioned nano-coated borosilicate electron tube (3) contains a 2 nm metal oxide coating on its outer wall, UV resistance, control of oxidation properties and anti-heating purpose. This structure is specially prepared with the plasma spray technique.

A metal is placed inside the nano-coated borosilicate electron tube (3) and thus control is achieved in the dielectric structure. Nano-coated borosilicate electron tubes (3) are placed between two SS304 electrode wires (4) and a system is prepared in which high voltage will be applied for the gas to be energized (B) coming from the outside.

The resistance of this system to heating is of great importance for the energizing process and for the originality of this reactor.

The wave structure of the potential induced by the reactor structure of providing energization (A) is in the form of a full sine wave at the resonance moment. At the peak of the negative alternance of this sine wave, instantaneous discharge of a capacitor bank creates an electromagnetic pulse effect on the reactor. With this effect, a change is created in the arrangement of the electrons in the orbitals of the oxygen molecules passing through the reactor structure of providing energization (A).

By connecting a voltage converter circuit connected to the primary of the transformer driving the reactor to a microcontroller, the signal structure of the voltage on the reactor, the potential value and the frequency of the signal can be monitored. In this way, it can be determined whether the sinusoidal voltage is at the peak or not and this peak is in the negative or positive alternans region.

Thanks to the software running in the microcontroller, the peak point of the negative alternance is detected and an instantaneous electromagnetic wave is formed on the reactor by discharging a capacitor bank connected to the primary of the transformer. This shock wave is repeated each time the peak of the negative alternating of the sinusoidal voltage is reached.

In the application subject to the invention, the gas to be energized (B) passes through the insulated PA6 reactor cover (1) and enters the reactor cell (2) formed from 7075 aluminum. The nano-coated borosilicate electron tube (3), located between the said SS304 electrode wire (4) and the reactor cell (2), creates a gas mixture energized by electron discharge from the conical nano pores (7) formed by opening 1000 pores (6) each time.

High-energy hydroxide and super-oxide structures are formed by small amounts of ozone, humidity in the environment, and energize it by changing the characteristic of the gas to be energized (B).

The gas to be energized (B) entering the said reactor cell (2) forms the activated and energized gas (C) at different rates and is transferred to the outside environment through the insulated PA6 reactor cover (1), passing through the reactor cell (2), ready to be used at certain rates.

Said reactor structure of providing energization (A) LC circuit is designed appropriately for energizing. As stated before in the working mechanism, if the structure is driven from an external source at a certain angular frequency (ω0), the inductive and capacitive reactances of this system reach a point where they are equal in magnitude. This point is basically the resonance point.

The said reactor structure of providing energization (A) is known to act as a capacitor since it has a dielelectric (insulator) material design between two SS304 electrode wire (4) materials. Here, a high voltage transformer with the appropriate topology is needed to energize reactor structure of providing energization (A). It is defined as high voltage transformer=L.
L=Inductance Henry (symbol: H)
C=Capacitance Farad (symbol: F)
ω0=Angular Frequency Rad (sembol: r)
f0=Equivalent frequency Hertz (sembol : Hz)

$$\begin{matrix}{ω}_{0} = \frac{1}{\sqrt{LC}} & {f}_{0} = \frac{{ω}_{0}}{2 π} = \frac{1}{2 π \sqrt{LC}}\end{matrix} .$$

A high voltage transformer with appropriate inductance is selected according to the capacitance value of the energized gas (C) reactor structure of providing energization (A) that provides energizing. Accordingly, the resonant frequency of the circuit is calculated based on the L and C values.

When we operate the circuit of the said reactor structure of providing energization (A) in a topology suitable for this frequency, the electric arcs that occur between the SS304 electrode wires (4) of the said reactor structure of providing energization (A) create a plasmic light. This structure can be observed in the form of violet.

The reactor structure of providing energization (A) subject to the invention is defined as a sustainable energizing reactor at 50-100 kV voltage levels. This reactor; It basically consists of 3 parts.
a—Preparation of the system to be used for energizing before the reactor
b—The main center of the reactor, which forms a specially designed dielectric system, contains nano-coated borosilicate electron tube (3) with special and uniform pores for temperature control in nanometric dimensions, and 2 nm metal oxide surface coating, which will function as the main point of energizing and
c—It is the necessary part to carry the gas mixture to the desired environment after energizing.

For the energized gas (C) structure of the purity required to be obtained for the reactor structure of providing energization (A), the gas to be energized (B) may need to be pretreated.

In order for the gas to be energized (B) to energize at the desired rates within the reactor structure of providing energization (A) some humidity should be provided.

The gas to be energized (B), which is concentrated after the pre-treatments, should be made suitable for the reactor structure of providing energization (A). In this way, an oxygen-based intense gas to be energized (B), whose energizing will result in more active results instead of air mixture, is transmitted to the reactor structure of providing energization (A).

The gas to be energized (B) mixture transmitted to the said reactor cell (2) and to be energized does not show any harmful behavior in any thermal change through the nano-coated borosilicate electron tube (3).

On the surface of the aforementioned nano-coated borosilicate electron tube (3), there are conical and regularly spaced pores (5). It is necessary to open these pores (5), since the electrical charge and the atmospheric plasma environment may briefly cause heating. In this way, the temperature drops to less than dangerous values and there is no danger of heating.

Said nano-coated borosilicate electron tube (3) is wrapped with SS304 electrode wire (4) on both sides in order to form a dielectric material.

A metal wire is placed inside the said nano-coated borosilicate electron tube (3). In this way, control is provided in the dielectric (insulator) structure.

The electrical voltage applied by a generator ionizes the gas molecules inside the room due to a high voltage.

The plasma structure, bond breakage and free electron formation, which is constantly directed due to the AC current, energizes the type of gas to be energized (B) due to ionization.

The energized gas (C) can then be transferred to the desired air, medium or solution. The energized gas (C), energized by the said reactor structure of providing energization (A), can be used in works such as disinfection, pathogen removal.

In the literature, energizing reactors are generally considered as ozone generators. However, UV light, cold plasma or electrical voltage is required for production and can also be obtained in different phases or environments.

In addition, the high power amounts required for reactors create the negative sides of ozone as an energized structure. Ozone energy also has side effects that cannot be stopped when oxidation starts and that will cause damage to the membranes, for example in disinfection processes.

Besides, different energizing processes can be used for cleaning, disinfection and oxidation purposes. In general, the energizing effect is around 10 kV for ozone structures.

However, the reactor structure of providing energization (A) subject to the invention can energize stably at 50-100 kV and has a geometric tendency to prevent temperature rise.

1. A reactor structure of providing energization, describes how a sustainable and stable mechanism is achieved for each step of the energizing process which is capable of energizing together with a voltage of 50-100 kV and provides for both small-sized portable and factory-sized, the reactor structure comprising: a reactor cell positioned to ensure that gas to be energized is turned into plasma by applying 50-100 kV with an AC circuit, a nano coated borosilicate electron tube which is formed between a lower and an upper reactor cell, which has great resistance to heating and cracking that may occur due to the applied high voltage and pores that provide proper heat distribution so that the voltage to be applied on the said nano-coated borosilicate electron tube does not damage the nano coated borosilicate electron tube.

2. A reactor structure of providing energization according to claim 1, comprising an SS304 electrode wire which is positioned on the top and bottom of the said nano coated borosilicate electron tube to allow the application of high voltage for the gas to be energized coming from the outside, and which forms dielectric material to enable the nano-coated borosilicate electron tube to act as a capacitor.

3. A reactor structure of providing energization according to claim 1, comprising a conical nanopore which is formed by opening 1000 pores and provides the formation of energized gas mixture with the electron discharge formed on the said nano coated borosilicate electron tube.

4. A reactor structure of providing energization according to claim 1, comprising metal wire located inside the nano coated borosilicate electron tube to provide control in the dielectric structure.

5. A reactor structure of providing energization according to claim 1, wherein 2 nm metal oxide coating is applied on the outer wall of said nano-coated borosilicate electron tube for the purpose of UV resistance, control of oxidation properties and heating prevention.

6. A reactor structure of providing energization according to claim 2, wherein said SS304 electrode wire is aluminum.
